(19) United States
(12) Patent Application Publication
(10) Pub. No.: US 2009/0065031 A1
(43) Pub. Date: Mar. 12, 2009

(54) METHOD FOR CLEANING A BOILER OF A FURNACE

(75) Inventors: Gerard Macneil, Surrey (CA); David Macneil, Langley (CA); Gordon Macneil, Delta (CA); Vernon Bose, Langley (CA)

Correspondence Address: VERMETTE & CO., SUITE 320 - 1177 WEST HASTINGS STREET, VANCOUVER, BC, V6E2K3, CA

(73) Assignee: MAC & MAC HYDRODEMOLITION INC., SURREY (CA)

(21) Appl. No.: 12/209,090

(22) Filed: Sep. 11, 2008

(30) Foreign Application Priority Data
Sep. 11, 2007 (CA) 2601493

(51) Int. Cl. B08B 3/02; B08B 3/04

(52) U.S. Cl. 134/34; 134/198

(57) ABSTRACT

A method of cleaning a waste boiler, comprising mounting a robot adjacent an interior surface of a wall of the boiler, the robot operative to emit a high pressure jet of fluid against an interior surface of the wall of the boiler. The robot is moved over the interior surface of the wall to clean the interior surface; and then moved over another wall of the boiler to cleaning that wall. These steps are repeated for each remaining uncleaned wall of said boiler.

### CROSS-REFERENCE TO RELATED APPLICATIONS

This application claims priority benefit of Canadian Patent Application 2,601,493 filed by Mac & Mac Hydrodemolition Inc on Sep. 11, 2007. incorporated herein by reference.

### FIELD

The present application relates to a method for remotely cleaning a boiler of a furnace.

### BACKGROUND

A problem with cleaning any furnace is the difficulty of getting off the residue left after operation. Another problem is the poisonous environment of some furnaces. In particular, the Kevcit smelter which is a slag furnace used in the recovery of zinc and co-products from the slag is one furnace that has a poisonous residue that includes thallium and arsenic. Referring to FIG. 1 the Kevcit smelter has a reaction shaft 10 into which feed material is inserted together with oxygen and the fluxing agents silica and limestone. The mixture ignites instantaneously to form hot sulphur dioxide gas and the lead, zinc, iron and other metals form metal oxides. The resulting semi-fused slag falls to the bottom of the first compartment along with the coarse coke. The dry feed is injected at the top of a reaction shaft of the Smelter together with oxygen. The coke collects as a surface layer, called a “coke checker”, floating on top of the molten slag. When the metal oxides percolate through this layer of burning coke, they are reduced and the lead is converted to metal as bullion.

The bullion continues to settle through the molten slag layer beneath the coke checker. Together with the zinc-bearing iron slag, the bullion passes under a partition wall into a compartment, which is an electric furnace. This partition wall extends into the molten slag forcing the hot sulphur dioxide gas to pass through a waste heat boiler and onto an electrostatic precipitator rather than into the electric furnace compartment

The metallic slag 12 containing all of the iron and most of the zinc from a Kivcet Furnace, is transferred in 70 tonne batches to a coal-fired fuming furnace (not shown). To recover the zinc, fine coal and air are injected one metre below the top of the slag bath. The heat generated causes the zinc to fume as a vapour from the furnace bath and is immediately reoxidized by tertiary air above the bath to form zinc oxide fume. These fumes and hot gases are cooled in a waste heat boiler 14 before passing through a baghouse to collect the zinc fumes for treatment in an adjacent Fume Leach Plant (not shown). The waste heat boiler 14, see FIG. 2, consists of a room having a plurality of closely spaced vertical pipes 16 against the walls 18. Water runs through these pipes 16 picking up heat from the gases inside and exiting as hot water or steam. In time deposits form over the exterior of the pipes, reducing their effectiveness in cooling the gases.

Traditionally, men clad only with masks, gloves and work clothes entered the room after it had been shut down and cooled and manually cleaned off the deposits. Considering that some of the deposits include thallium, arsenic and other deadly contaminants, any accidental contact with the skin could be fatal. Consequently, a method of cleaning the boiler is needed which minimizes human contact.

### SUMMARY OF THE INVENTION

According to the invention there is provided a method of cleaning a boiler of a furnace, which comprises mounting a robot adjacent an interior surface of a wall of the boiler. The robot is operative to emit a high pressure jet of fluid against an interior surface of the wall of the boiler. The robot is moved over the interior surface of the wall to clean the interior surface; and then moved over another wall of the boiler to clean that wall. These steps are repeated for each remaining uncleaned wall of the boiler; and removing the waste water and particulate material from the boiler.

The mounting step may include suspending a pair of cables down alongside a wall of said boiler, adjacent an interior surface of a wall to be cleaned, attaching ends of the robot to respective ones of the cables so that the ends lie in a horizontal plane, the robot being reversibly moveable up and down the wall; and attaching a first high pressure water line to the robot with the water line having a holding nozzle emitting water away from the wall so as to provide a thrust toward the wall which counteracts a force generated by the water emitted from the robot.

An elongated rail is suspended at either end by the cables. A carriage containing a first carriage nozzle is mounted on the rail, with the carriage reversibly moveable along the rail. A high pressure water line is connected to the first carriage nozzle, with the first carriage nozzle operative to emit a jet of water towards the wall when the water line is opened. The rail is moved from one of a top and bottom of the wall to another of the top and bottom of the wall, and moving the carriage from one end of the rail to another, cleaning the wall as the carriage moves. The foregoing steps are repeated for each remaining uncleaned wall.

A second high pressure water line is coupled to said robot at an opposite end of said rail to said first high pressure water line with a high pressure water line terminating in a holding nozzle directed opposite to said first carriage nozzle.

The cable is wound on drums supported by a support structure proximate a ceiling and rotating the drums in response to control signals from a user.

The method further includes affixing the cable to gear systems at either end of the rail which allows the rail to move up and down the cable.

The rail commences operation at a top of the wall and moves downwardly. Movement may be incremental or continuous.

Advantageously, coupling second and third high pressure water lines to said rail proximate either end thereof, each line having a holding nozzle directed away from the wall to hold the rail against the wall when water emanates from the holding nozzles. A greater pressure is applied to the holding nozzles than to the first carriage nozzle. A second carriage nozzle may be located on the carriage below the first carriage nozzle.

According to another aspect of the invention there is provided a method of cleaning a boiler of a furnace, which comprises suspending a pair of spaced apart cables down adjacent an interior surface of a wall to be cleaned of the boiler. Ends of the rail are attached to cables so that the rail is substantially horizontal. The rail is reversibly moveable up and down the wall. A carriage with a pair of nozzles, one above another on the rail, is reversibly moveable along the rail. A first high-pressure water line is coupled to the carriage nozzle, with the carriage nozzle operative to emit jets of water when the water lines are opened. The rail is moved from one of a top and bottom of the wall to another of the top and bottom of the wall, and moving the carriage from one side of the rail to the other, cleaning the wall as it moves. A second high pressure water line is coupled to a holding nozzle with the holding nozzle directed in a direction opposite to said carriage nozzle and operative to counteract a force of the jet of the carriage nozzle. The foregoing steps are repeated for each remaining uncleaned wall.

In another aspect of the invention there is provided an apparatus for cleaning a boiler of a furnace which includes a robot mounted adjacent an interior surface of a wall of the boiler. The robot has a carriage nozzle operative to emit a high pressure jet of fluid against an interior surface of the wall of the boiler. A cable is suspended on either side of the robot and the robot is operative to move laterally across the wall between the cables and vertically up and down the cables. A rail extends between and is moveably coupled to the cables. The robot moves over the rail and the holding nozzle is mounted on the rail and is operative to counteract a reaction force on the rail caused by a jet of fluid emitted by the nozzle,

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a perspective view of the Kivcet Flash Smelter showing some of the process steps;

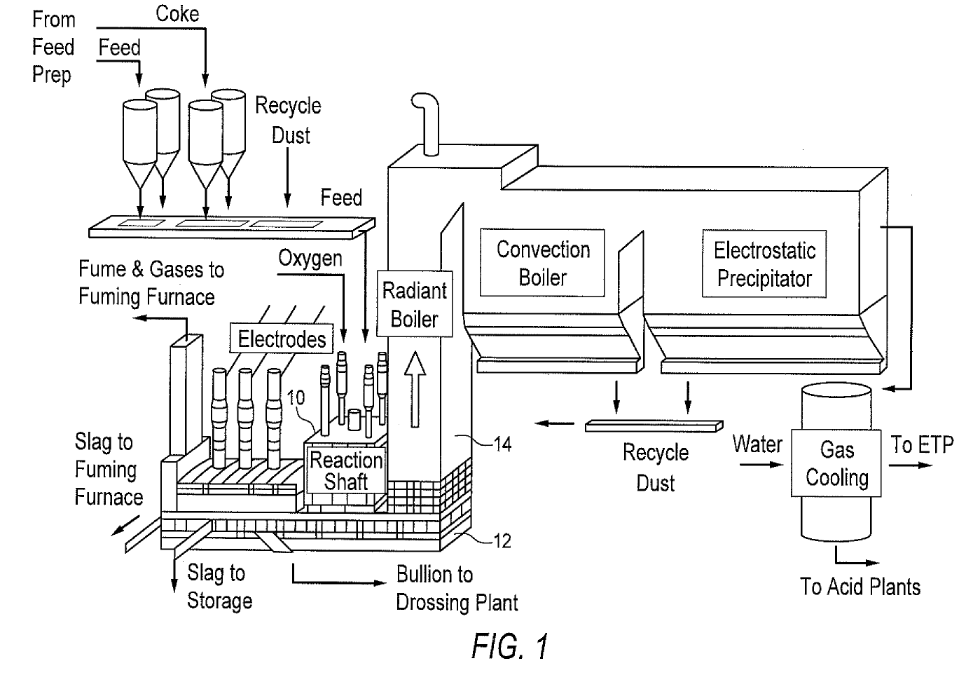

FIG. 2 is a perspective view of the boiler with the room cut away;

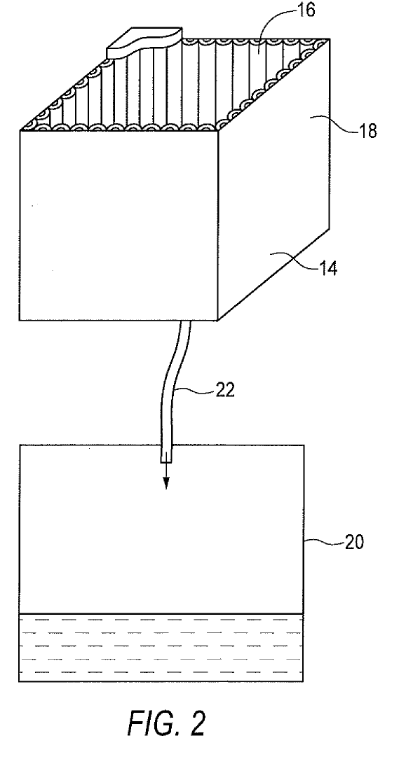

FIG. 3 is a perspective view of a portion of cleaning robot which cleans the outer surface of the heat exchanging pipes;

FIG. 4 is a perspective view of the boiler showing the cleaning robot suspended from cables passing through the roof and wound around respective winches;

FIG. 5 is a perspective view of the cleaning robot showing the rail, the carriage, and the mounting blocks.

### DETAILED DESCRIPTION WITH REFERENCE TO THE DRAWINGS

In the following high pressure water jetting shall mean cleaning performed at pressures sufficiently high to remove scale and build-up on the sides of the boiler. Like reference numbers refer to like parts.

In preparation for cleaning the boiler 14, a waste storage tank 20 is coupled to the boiler 14 by means of a drain line 22 which couples the bottom of the boiler 14 to the top of the waste tank 20. Any fluid running down the walls of the tubes 16 flows into drain line 22 and into waste storage tank 20. In some instances the drain line 22 could simply run into a sewer line.

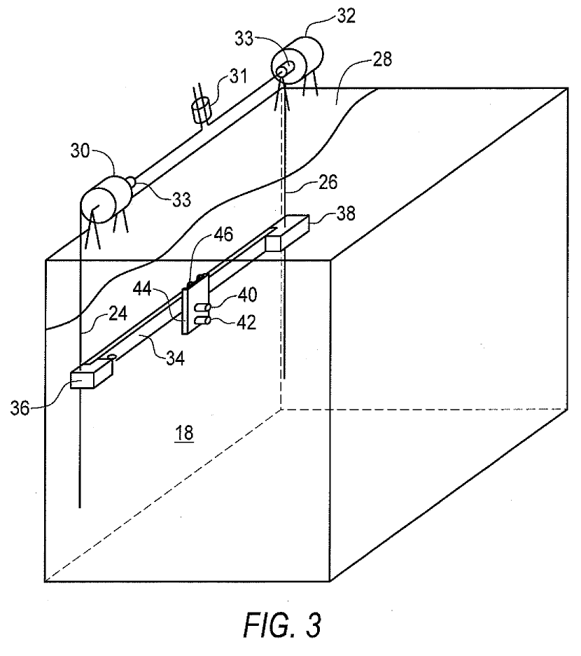

Once the waste storage tank 20 has been connected, the cleaning robot is set up as seen in FIG. 3. In this case two cables 24 and 26 are wound around respective drums 30 and 32 mounted on the roof 28 and hang down through the roof 28 adjacent an interior of one of walls 18. With certain boilers one can simply hand the cables from a framework near the ceiling. A rail 34 extends from one side of a wall to be cleaned to the other and is affixed to a pair of mounting blocks 36 and 38 located at either end of rail 34. The mounting blocks function as bumpers preventing the nozzles 40 and 42 from contacting the wall.

A carriage 44 consisting of a mounting plate and three rail engaging wheels 46 moves from one side of rail 34 to the other, powered by a motor (not shown). Mounted on a mounting plate are two vertically spaced apart nozzles 40 and 42. Two separate high pressure water lines (not shown) are coupled to nozzles 40 and 42. In order to simplify the drawing no hoses or electrical components have been shown. Drums 30 and 32 each have motors with remotely operated controllers 33 coupled to a user control (not shown) by lines 31. Drums 30 and 32 can be used to raise the rail assembly as the rail assembly is operating. A fixed connection to cables 24 and 26 can be replaced with a remotely controlled cable gripping gear system that allows the rail 34 to move up relative to the cables 24 and 26. A pair of water hoses 54 and 56 are attached to rail 34 adjacent mounting blocks 36 and 38, respectively, and have nozzles 50 and 52 that emit jets of water opposite to wall 18. The momentum transfer of the jets cause a force on rail 34 that counteracts the force produced by the water emitted from jets 40 and 42.

In operation, the rail 34 is raised up to be adjacent the roof 28 by drums 30 and 32. Pressurized water is applied to nozzles 40 and 42 with 40,000 psi applied to nozzle 42 and to nozzle 40. After the first pass of the nozzles 40 and 42, the rail is moved down a few inches and high pressure is re-applied to nozzles 40 and 42 and another pass of nozzles 40 and 42 is made. The rail 34 is lowered by drums 30 and 32 to a next position below the first pass. The nozzles 40 and 42 again travel across the wall 18 cleaning additional swaths. This incremental travel is repeated until the entire wall 18 has been cleaned. Waste water and removed particles drop to the floor and flow to waste tube 22 and, then, to the waste storage tank 20. Optionally, the waste water and removed particles could be allowed to drain directly into a sewer line. When one wall has been cleaned, the room is dried and the cleaned apparatus moved to an adjacent wall and the process is repeated, until all four walls have been cleaned. It is possible to start at a bottom of a wall and progress upwardly but all of the cleaned material would drop down on the rail and other parts of the cleaned apparatus. It is also possible to operate two or more rail assemblies 35 on two or more walls at the same time to speed up the cleaning process. The purpose of the ultra high pressure being applied to nozzle 42, is to smoothen out the wall and to blow away any residue left on the wall by operation of nozzle 40.

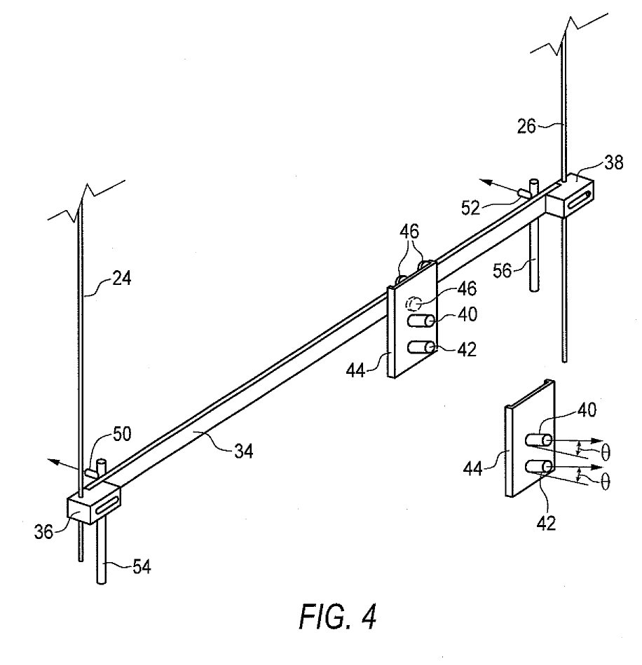

A modified rail assembly is shown in FIG. 4. The carriage 44 has two wheels 46 which provide vertical support to the carriage and a horizontally disposed wheel 47 which engages an opposite side of the rail to maintain alignment of the carriage 44. Blocks 36 and 38 engage cables 24 and 26 and have a gear system which allows progressive movement along cables 24 and 26.

Rather than moving incrementally and stopping, one can also run the rail so it rises continuously and the nozzles 40 and 42 move without stopping, from one side of the rail to the other. While the method has described sequential cleaning of adjacent walls, as mentioned above, it is possible to clean more than one wall at a time. Water lines 54 and 56 and associated nozzles 50 and 52 provide a thrust that counteracts the thrust from the water emitted from nozzles 40 and 42. However, there will be a torque that increases from zero at the center of the rail to a maximum value at either end. As a further refinement the water flow out of the nozzles 50 and 52 may be varied to compensate for this torque or else the volume of water emitted by the water lines 54 and 56 would have to be increased to be greater than that of the nozzles 40 and 42. Finally, as shown in the separated drawing of the carriage 44 in FIG. 4 as the carriage approaches an end of the rail, the nozzles 40 and 42 are pivoted automatically in order to clean the area around the corner of the room.

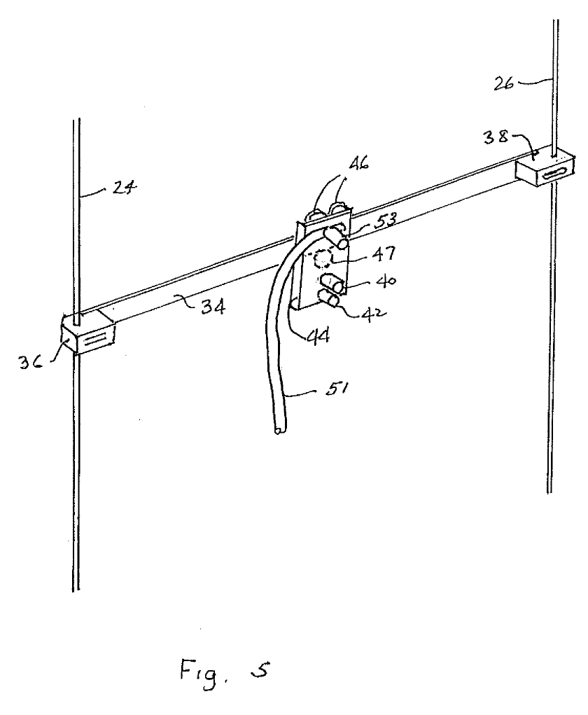

FIG. 5 is an alternative embodiment in which a single hose 51 and nozzle 53 is attached to carriage 44 and travels with the latter. In this case the jet from nozzle 53 is always aligned with the jets from nozzles 40 and 42, thereby avoiding any torque imbalance.

If the surface to be cleaned 18 is curved, then rail 34 would have to be curved with the same curvature as surface 18 so that the nozzles 40 and 42 would be kept at a constant distance from surface 18 as the carriage 44 runs along rail 34. Obviously, sharp curves could not be accommodated.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

We claim:

1 A method of cleaning a boiler, comprising:
(a) mounting a robot adjacent an interior surface of a wall of said boiler, said robot operative to emit a high pressure jet of water against an interior surface of said wall of said boiler,
(b) moving said robot over the interior surface of said wall to clean said interior surface;
(c) moving said robot to another wall of said boiler and cleaning that wall,
(d) repeating step (c) for each remaining uncleaned wall of said boiler; and
(e) removing waste water and particulate material from said boiler.

2. The method of claim 1, wherein said mounting step includes:
(a) suspending a pair of cables down alongside a wall of said boiler, adjacent an interior surface of a wall to be cleaned;
(b) attaching ends of said robot to respective ones of said cables so said ends lie on a horizontal plane, said robot being reversibly moveable up and down said wall; and
(c) attaching a first high pressure water line to said robot with said water line having a holding nozzle emitting water away from said wall so as to provide a thrust toward said wall which counteracts a force generated by said water emitted from said robot.

3. The method of claim 2, wherein said robot includes an elongated rail suspended at either end from said cables and further includes:
(d) mounting a carriage containing a first carriage nozzle, on said rail, with said carriage reversibly moveable along said rail;
(e) coupling a high pressure water line to said first carriage nozzle, with said first carriage nozzle operative to emit a jet of water towards said wall when said water line is opened;
(f) moving said rail from one of a top and bottom of said wall to another of said top and bottom of said wall, and moving said carriage from one end of said rail to another, cleaning said wall as said carriage moves;
repeating steps (c) to (e) for each remaining uncleaned wall.

4. The method of claim 3, including coupling a second high pressure water line to said robot at an opposite end of said rail to said first high pressure water line with a high pressure water line terminating in a holding nozzle directed opposite to said first carriage nozzle.

5. The method of claim 3, including winding said cable on drums supported by support structure proximate a ceiling and rotating said drums in response to control signals from a user.

6. The method of claim 3, including affixing said cables to gear systems at either end of said rail which allows said rail to move up and down said cable.

7. The method of claim 3, wherein said rail commences operation at a top of said wall and moves downwardly.

8. The method of claim 3, including coupling second and third high pressure water lines to said rail proximate either end thereof each line having a holding nozzle directed away from said wall to hold said rail against said wall when water emanates from said holding nozzles.

9. The method of claim 8, wherein a greater momentum is applied by the jet from said holding nozzles than from said first carriage nozzle.

10. The method of claim 3, including mounting a second carriage nozzle on said carriage below said first carriage nozzle.

11. The method of claim 10, wherein a high pressure is applied to the first carriage nozzle and an ultra high pressure greater than said high pressure is applied to the second carriage nozzle.

12. The method of claim 1, wherein said waste water and particulate matter is directed to a waste tank.

13 The method of claim 1, wherein said waste water and particulate matter is allowed to flow into a sewer line.

14. The method of claim 3, including a bumper on one of said carriage and rail to prevent said carriage nozzles from contacting said wall.

15. The method of claim 4, wherein said carriage nozzles are pivotal as said carriage approaches an end of said rail so that it can clean an area near a corner of a room.

16. The method of claim 4, wherein said rail moves in increments.

17. A method of cleaning a boiler of a furnace, comprising:
(a) suspending a pair of spaced apart cables down adjacent an interior surface of a wall to be cleaned of said boiler;
(b) attaching ends of the rail to respective ones of said cables so said rail is substantially horizontal, said rail being reversibly moveable up and down said wall;
(c) mounting on said rail a carriage containing a carriage nozzle, with said carriage reversibly moveable along said rail;
(d) coupling a first high pressure water line to said carriage nozzle, with said carriage nozzle operative to emit a jet of water towards said wall when said water line is opened;
(e) moving said rail from one of a top and bottom of said wall to another of said top and bottom of said wall, and moving said carriage from one side of said rail to another cleaning said wall as it moves;
(f) coupling a second high pressure water line to a holding nozzle with said holding nozzle directed in a direction opposite to said carriage nozzle and operative to counteract a force of the jet of said carriage nozzle;
repeating steps (a) to (f) for each remaining wall.

18. The method of claim 17, wherein said holding nozzle is mounted on said carriage and moves with said carriage nozzle.

19. The method of claim 17, wherein said holding nozzle is mounted proximate one end of said rail and a second holding nozzle is mounted proximate another end of said rail and said second high pressure water line is coupled to said holding nozzle and a third high pressure water line is coupled to said second holding nozzle, said second holding nozzle and said third holding nozzle being directed away from said wall to counteract the reaction force of water jets emitted from said carriage nozzles.

20. The method of claim 19, including winding said cable on drums supported on or proximate a roof or ceiling and rotating said drums in response to control signals from a user.

21. The method of claim 19, affixing said cable to a ceiling or roof and attaching it to a gear system at said rail which allows the rail to move up and down said cable.

22. The method of claim 18, wherein commencing movement of said rail at a top of said wall and moving downwardly.

23. The method of claim 21, wherein applying a greater pressure to a top one of said carriage nozzles than to a bottom one.

24. The method of claim 21, wherein applying an ultra high pressure to a top one of said carriage nozzles and applying a high pressure to a bottom one, wherein said ultra high pressure is greater than said high pressure.

25. The method of claim 17, wherein commencing said rail operation at a bottom of said wall and applying an ultra high pressure to a bottom one of said carriage nozzles while applying a high pressure to a top one of said carriage nozzles, wherein said ultra high pressure is greater than said high pressure.

26. The method of claim 18, including a waste line coupled at one end to a floor of said boiler and at another end to a waste tank and operative to drain waste from said boiler to said waste tank.

27. The method of claim 18, wherein said waste water and particulate matter is allowed to flow into a sewer line.

28. The method of claim 18, including a bumper on one of said carriage and rail to prevent said carriage nozzles from contacting said wall.

29. The method of claim 19, wherein said carriage nozzles are pivotal as said carriage approaches an end of said rail so that it can clean an area near a corner of a room.

30. Apparatus for cleaning a boiler of a furnace, comprising:
(a) a robot mounted adjacent an interior surface of a wall of said boiler, said robot having a carriage nozzle operative to emit a high pressure jet of fluid against an interior surface of said wall of said boiler;
(b) a cable suspended on either side of said robot, said robot operative to move laterally across said wall between said cables and vertically up and down said cables;
(c) said robot having a rail extending between and moveably coupled to said cables over which said robot moves, said holding nozzle mounted on said rail and operative to counteract a reaction force on said rail caused by a jet of fluid emitted by said carriage nozzle,

31. Apparatus according to claim 30, wherein said robot comprises a carriage moveably mounted on said rail, said carriage having a first carriage nozzle and having said holding nozzle mounted thereon.

32. Apparatus according to claim 31, wherein said carriage has a second carriage nozzle located below said first carriage nozzle and said carriage is reversibly moveable along said rail.

33. The method of claim 31, wherein a greater pressure is applied to a one of said carriage nozzles that is behind another of said carriage nozzles in a direction of travel of said rail.

34. The method of claim 31, wherein a high pressure is applied to said another nozzle and an ultra high pressure is applied to said one nozzle.
